(19) United States
(12) Patent Application Publication
(10) Pub. No.: US 2016/0189752 A1
(43) Pub. Date: Jun. 30, 2016

(54) CONSTRAINED SYSTEM REAL-TIME CAPTURE AND EDITING OF VIDEO

(71) Applicants: Yaron GALANT, Palo Alto, CA (US); Martin Paul BOLIEK, San Francisco, CA (US)

(72) Inventors: Yaron GALANT, Palo Alto, CA (US); Martin Paul BOLIEK, San Francisco, CA (US)

(21) Appl. No.: 14/983,323

(22) Filed: Dec. 29, 2015

Related U.S. Application Data
(60) Provisional application No. 62/098,173, filed on Dec. 30, 2014.

(51) Int. Cl. G11B 27/034; G11B 27/28; H04N 5/77

(52) U.S. Cl. CPC G11B 27/034; H04N 5/772; G11B 27/28

(57) ABSTRACT

A method and apparatus for performing real-time capture and editing of video are disclosed. In one embodiment, the method comprises editing, on a capture device, raw captured media data by extracting media data for a set of highlights in real-time using tags that identify each highlight in the set of highlights from signals generated from triggers; creating, on the capture device, a video clip by combining the set of highlights; and processing, during one or both of editing the raw input data and creating the video clip, a portion of the raw captured media data that is being stored in a memory on the capture device but not included in the video clip during one or both of editing the raw input media data and creating the video.

### PRIORITY

The present patent application claims priority to and incorporates by reference the corresponding provisional patent application Ser. No. 62/098,173, titled, “Constrained System Real-Time Editing of Long Format Video,” filed on Dec. 30, 2014.

### RELATED APPLICATIONS

The present patent application is related to and incorporates by reference the corresponding U.S. patent application Ser. No. 14/190,006, titled, “SYSTEMS AND METHODS FOR IDENTIFYING POTENTIALLY INTERESTING EVENTS IN EXTENDED RECORDINGS,” originally filed on Feb. 25, 2014.

### TECHNICAL FIELD

The technical field relates to systems and methods to processing recordings. More particularly, the technical field relates to systems and methods for identifying potentially interesting events in recordings. These embodiments are especially concerned with identifying these events given a constrained system environment.

### BACKGROUND

Portable cameras (e.g., action cameras, smart devices, smart phones, tablets) and wearable technology (e.g., wearable video cameras, biometric sensors, GPS devices) have revolutionized recording of activities. For example, portable cameras have made it possible for cyclists to capture first-person perspectives of cycle rides. Portable cameras have also been used to capture unique aviation perspectives, record races, and record routine automotive driving. Portable cameras used by athletes, musicians, and spectators often capture first-person viewpoints of sporting events and concerts. As the convenience and capability of portable cameras improve, increasingly unique and intimate perspectives are being captured.

Similarly, wearable technology has enabled the proliferation of telemetry recorders. Fitness tracking, GPS, biometric information, and the like enable the incorporation of technology to acquire data on aspects of a person's daily life (e.g., quantified self).

In many situations, however, the length of recordings (i.e., footage) generated by portable cameras and/or sensors may be very long. People who record an activity often find it difficult to edit long recordings to find or highlight interesting or significant events. For instance, a recording of a bike ride may involve depictions of long stretches of the road. The depictions may appear boring or repetitive and may not include the drama or action that characterizes more interesting parts of the ride. Similarly, a recording of a plane flight, a car ride, or a sporting event (such as a baseball game) may depict scenes that are boring or repetitive. Even one or two minutes of raw footage can be boring if only a few seconds is truly interesting. Manually searching through long recordings for interesting events may require an editor to scan all of the footage for the few interesting events that are worthy of showing to others or storing in an edited recording. A person faced with searching and editing footage of an activity may find the task difficult or tedious and may choose not to undertake the task at all.

In many video capture system environments, particularly portable and wearable devices, there are constraints that must be considered. For example, cameras have limited computational capabilities. Smart phones, tablets, and similar devices have limited memory for captured video. And most mobile devices have limitations on bandwidth and/or charges related to data transfer volume.

A key constraint in many mobile systems is memory. With limited memory, it is difficult to capture long-form video. (The term “long-form” here means the capture of several minutes, even hours, of video, either contiguous or in several short segments. It is assumed that capturing everything in an event assures that the interesting moments will not be missed. However, this leads directly to the issues about editing, memory, bandwidth, energy consumption, and computation burden described above.) For example, High Definition (HD) video has 1080 lines per frame and 1920 pixels per line. At 30 frames per second and 3 bytes per pixel, that is a data rate of 656 GB/hour. Even with an impressive compression rate of 100:1, this video rate creates over 6 GB/hour. Only a couple hours of raw video would challenge all but the most advance (and often expensive) mobile devices.

Another constraint is bandwidth. Transferring even an hour of video would be a long laborious task even with a wired connection (e.g., USB 3.0). It would be painfully slow and perhaps costly to transfer across a cell network or even WiFi.

A further constraint is computation. Even the most powerful desktop computers are challenged when editing video with a modern video editing software program (e.g., Apple's iMovie, Apple's Final Cut Pro, GoPro's GoPro Studio). Also these programs do not perform video analysis on the content. They merely present the media to the user for manual editing and recompose the file video. Automated editing systems that analyze the content (such as face recognition, scene and motion detection, and motion stabilization) require even more computation or specialized hardware.

A system without these constraints is able to capture all of the long-form video at maximum resolution, frame rate, image and video quality. Additionally, all related sensor data (described below) can be captured at the full resolution and quality. However, in a system with memory, computation, bandwidth, data volume or other constraints, decisions on the capture of the video and/or related sensor data needs to occur in “real-time” or there is a risk of losing critical captured data.

### SUMMARY

A method and apparatus for performing real-time capture and editing of video are disclosed. In one embodiment, the method comprises editing, on a capture device, raw captured media data by extracting media data for a set of highlights in real-time using tags that identify each highlight in the set of highlights from signals generated from triggers; creating, on the capture device, a video clip by combining the set of highlights; and processing, during one or both of editing the raw input data and creating the video clip, a portion of the raw captured media data that is being stored in a memory on the capture device but not included in the video clip during one or both of editing the raw input media data and creating the video.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates one embodiment of a smart device, wearable device, or action camera.

FIG. 2 illustrates a data flow between components of one embodiment of a general automated video editing system.

FIG. 3 depicts the timing relationship between the artifacts of the components of one embodiment of a general automated video editing system.

FIG. 4 depicts the relationship of the sensor data real-time loops, the video (media) real-time loops, and successive loops according to one embodiment.

### DETAILED DESCRIPTION

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some of these embodiments describe the adaption of the embodiments described in U.S. patent application Ser. No. 14/190,006, titled, “SYSTEMS AND METHODS FOR IDENTIFYING POTENTIALLY INTERESTING EVENTS IN EXTENDED RECORDINGS”, filed on Feb. 25, 2014 to a system with these constraints.

Automated and machine assisted editing of long-form video reduces manual labor burden associated with video editing by automatically finding potentially interesting events, or highlights, capture in the raw video stream. These highlights are detected and evaluated by measuring associated sensor data (e.g., GPS, acceleration, audio, video, tagging, etc.) against trigger conditions.

In many video capture system environments there are constraints that must be considered. For example, cameras have limited computational capabilities. Smart phones, tablets, and similar devices have limited memory for captured video. Furthermore, most mobile devices have limitations on bandwidth and/or charges related to data transfer volume.

Certain embodiments describe the system, methods, and apparatus for implementing trigger conditions, trigger satisfaction, sensor conditions, and sensor data modules in constrained system environments. Furthermore, certain embodiments describe the real-time effect on the video and/or related sensor data capture.

To overcome the constraint of limited bandwidth, certain embodiments perform most, or all, of the highlight detection, extraction, and video creation on device itself. The raw capture media does not need to be transferred. In some embodiments, only the summary movie is transferred only if it is shared. In other embodiments, only some of the computational byproducts are transferred, if necessary, to overcome computational limitations. In some embodiments, some rough cut (not raw) video and metadata are transferred for use by offline machine learning systems used to improve the system.

In one embodiment, signals adjacent to the video data and triggers for salient events are used with far less computation (and often with better precision and recall) than required of video analysis based systems.

To overcome the constraint of limited memory or storage, the detection of a highlight is performed in real-time (as described below). A highlight is defined as a range of time that an interesting moment is detected. There are several automated and manual techniques for finding and relative scoring of highlights described in U.S. patent application Ser. No. 14/190,006, entitled, “SYSTEMS AD METHODS FOR IDENTIFYING POTENTIALLY INTERESTING EVENTS IN EXTENDED RECORDINGS”, filed Feb. 25, 2014 and U.S. patent application Ser. No. 14/879,854, entitled “VIDEO EDITING SYSTEM WITH MULTI-STAKEHOLDER, MULTI-STAGE CONTROL”, filed Oct. 9, 2015, both of which are incorporated herein by reference. The media associated with that highlight (e.g., audio, video, annotation, etc.) is marked, extracted and preserved separately, and/or given higher resolution, quality, frame rate, or other consideration. In one embodiment, these highlights are called Master Highlights and the repository of this information is called the Master Highlight List (MHL). The highlight's metadata are entered in a set of data referred to herein as the MHL Data and the associated media are stored in a data set referred to herein as the MHL Media, and the automated summary movie is produced from the MHL Data and MHL Media.

In one embodiment, the entries in the Master Highlight List are again evaluated with respect to each other and user preferences, perhaps several times, to create the best set of Master Highlights for preservation. This ensures that the memory required for MHL itself will remain within a target limit. It is from this refined Master Highlight List that one or more summary movies are produced.

In one embodiment, real-time is defined as the video capture rate. The allowable latency before a decision on a highlight must be made without losing media data is a function of the memory available for the system. In some cases, that memory is capable of storing the media longer than the activity being captured, therefore the latency is not an issue. In most cases, however, the memory is less than the activity and a real-time decision needs be made to preserve the media data.

Note that the recognition of a highlight is used in different ways in different embodiments. In one embodiment, only the highlights are preserved and the rest of the media is discarded to free memory space for the newly captured media. In another embodiment, highlights are preserved at higher resolution (e.g., 1080p as opposed to 320p), frame rate (e.g., 30 or 60 fps as opposed to 15 fps), quality (e.g., 1 MB/s as opposed to 100 kB/s), or other consideration, than the rest of the media stream. With progressive or streaming media formats, it is a straight-forward technical design to reduce the non-highlight data size in real-time as memory space is needed.

As mentioned above, the MHL contents are evaluated in real-time to improve the quality of the highlights given the constraints. For example, if the memory allocated to the Master Highlights List is sufficient for all the Master Highlights, all the highlights are preserved at full quality, etc. However, if the activity creates more highlights that can be stored, one or more evaluation loops are performed to decide which highlights are preserved, which are reduced in size, and/or which are discarded entirely.

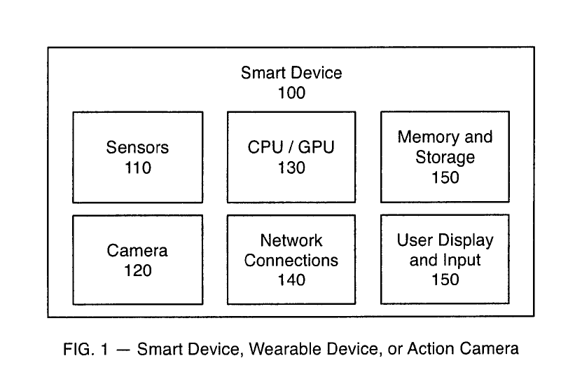

First, to better understand the capabilities and constraints that these smart devices provide, one embodiment of a device is shown in FIG. 1. Referring to FIG. 1, smart device 100 is used to describe certain devices that may be used with certain embodiments. In one embodiment, smart device 100 is a collection of devices that are connected or networked to achieve some, or all, of these functions. In one embodiment, smart device 100 contains various sensors 110 such as, for example, but not limited to, GPS, accelerometers, gyroscopes, barometers, heart rate, bio temperature, outside temperature, altimeter, and so on.

In one embodiment, smart device 100 has one or more cameras 120 capable of HD (or lessor) video and/or still images. In one embodiment, smart device 100 also has many of the same components as a traditional computer including a central processing unit (CPU) and/or a graphics processing unit (GPU) 130, various types of wired and wireless device and network connections 140, removable and/or non-removable, volatile and/or non-volatile memory and/or storage 150 of various types, and user display and input 150 functions.

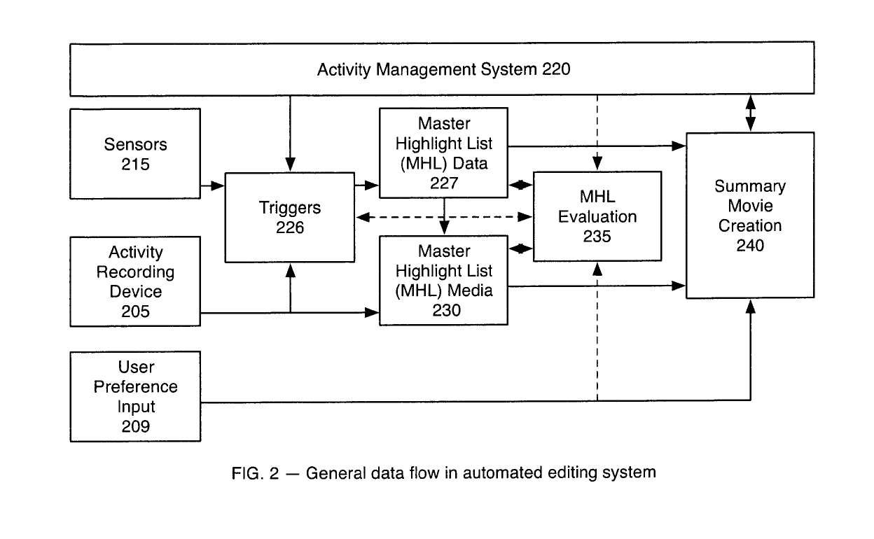

To better understand the system, methods, and apparatus used herein it is useful to look at the general block diagram (FIG. 2) and compare the automated and semi-automated data and control flow to that of a strictly manual traditional video editing process.

Referring to FIG. 2, the automated and semi-automated system of certain embodiments receive media data of many types (e.g., video, audio, annotation) from one or more activity recording device(s) 205. Additionally, a number of sensors 215 (e.g., accelerometers, gyroscopes, GPS, user tagging, etc.) provides sensor data for additional information synchronous in time with the media data. Also, the users have the ability to affect the operation of the system and manipulate the editing of the summary movie with the user preferences input 209.

In one embodiment, the sensor data, media data, and learning data (from activity management system 220 describe below) are used by triggers 226 in embodiments described in U.S. patent application Ser. No. 14/190,006 “SYSTEMS AND METHODS FOR IDENTIFYING POTENTIALLY INTERESTING EVENTS IN EXTENDED RECORDINGS”, filed Feb. 25, 2014. When trigger conditions are satisfied, an event is detected. In one embodiment, the appropriate information about the event (e.g., start time, duration, relative importance score, trigger condition context) are recorded in MHL data 227.

In one embodiment, the raw media data is preserved in MHL media storage 230 and is unaffected by the master highlights list. In another embodiment, the raw media data is affected by the Master Highlights before being stored in MHL media storage 230. In one embodiment, the effect is to extract the media data into separate media files (rough cut clips). The raw media data can then be discarded, freeing up memory for the media data that follows. In one embodiment, the video resolution, video frame rate, video quality, audio quality, audio sample rate, audio channels, annotation are altered before storing in MHL media storage 230. In this embodiment, some or all of the raw video is preserved, albeit at a lower quality and bitrate.

The Master Highlight List is evaluated by MHL evaluation unit 235. Based on triggers 226, the learning data, the user preferences as well as the content of the MHL data 227 and MHL media 230, these evaluations determine the best relative scoring, context, position, and importance of the highlights and the clips based on the media data, sensor data, user preference, and prior leaning information. In one embodiment, these evaluations are run multiple times to achieve the optimal set of highlights and rough cut clips. The results of MHL evaluation unit 235 often alters the contents of MHL data storage 227 and/or MHL media storage 230. Additionally, in one embodiment, the MHL evaluation unit 235 can affect the parameterization of the trigger conditions in triggers 226 for the detection of future highlight events.

The summary movie is created in summary movie creation unit 240. Summary movie creation unit 240 comprises hardware, software, firmware or a combination of all three. In one embodiment, the function performed by movie creation unit 240 is based on input from the learning data, alternate viewpoint highlight and media data (from activity management system 220 described below) and the user preferences as well as the master highlight list and the rough cut clips. In one embodiment, the summary movie is created from the all, or a subset (e.g., the best subset), of the rough cut clips and/or alternate viewpoint media data. In one embodiment, multiple summary movies are created from the same rough cut clips and highlights which differ according to the usage context (e.g., destination and/or use for the summary movie) or user preferences.

In one embodiment, summary movie creation unit 240 has an interactive user interface that allows the user to modify preferences and see the resulting movie before the summary movie creation. In one embodiment, the summary movie is actually created and presented from the rough cut clips in real-time. In one embodiment, rather than creating a coherent movie file, the “movie” is an ephemeral arrangement of the rough cuts and can be altered by the viewer. The altering by the viewer may occur according to techniques described in U.S. patent application Ser. No. 62/217,658, entitled “HIGHLIGHT-BASED MOVIE NAVIGATION AND EDITING”, filed Sep. 11, 2015, and U.S. patent application Ser. No. 62/249,826, entitled “IMPROVED HIGHLIGHT-BASED MOVIE NAVIGATION, EDITING AND SHARING”, filed Nov. 2, 2015, both of which are incorporated by reference.

In one embodiment, activity management system 220 performs several functions in the system. First, it controls and synchronizes the modules in the system. (Control connections are not shown in FIG. 2 to avoid obscuring the present invention.) Second, it interacts with various machine learning systems (not shown in FIG. 1) that affect the parameterization and optimization of the trigger conditions, the MHL evaluation iterations, and the summary movie creation. Third, it delivers alternate viewpoint media data (e.g., video and audio of the same event from cameras and systems not directly controlled by this system) to summary movie creation unit 240. Fourth, is manages the sharing of the summary movies. Fifth, it archives and/or sends the sensor data, rough cut clips, and master highlights to the machine learning systems.

Comparing this flow to a manual editing system by analogy should help comprehend the various components. The video editor is the person or persons who use state-of-the-art software (e.g., Apple's Final Cut Pro) to perform many of these functions. The video editor's knowledge and skill vary from person to person. In some sense, the relative skill of the video editor is analogous to the machine learning performed in certain embodiments.

The video editor replaces both user preference input 209 and activity management system 220. In a manual system there may or may not be any sensors 215. If there are sensors 215, the sensor data is usually limited to user tags.

The video editor creates a shot list that is equivalent to the master highlight list. In one embodiment, this is done by viewing the video or using manually writing timing notes. From this list, the video editor manually (using the software) determines the beginning, duration, and order of the shots and extracts the rough cut clips. This is sometimes called the initial assembly (http://en.wikipedia.org/wiki/Rough_cut).

From these clips, the video editor refines the list into a series of rough cuts. Finally, the clips are put together, with the right transitions for the summary movie.

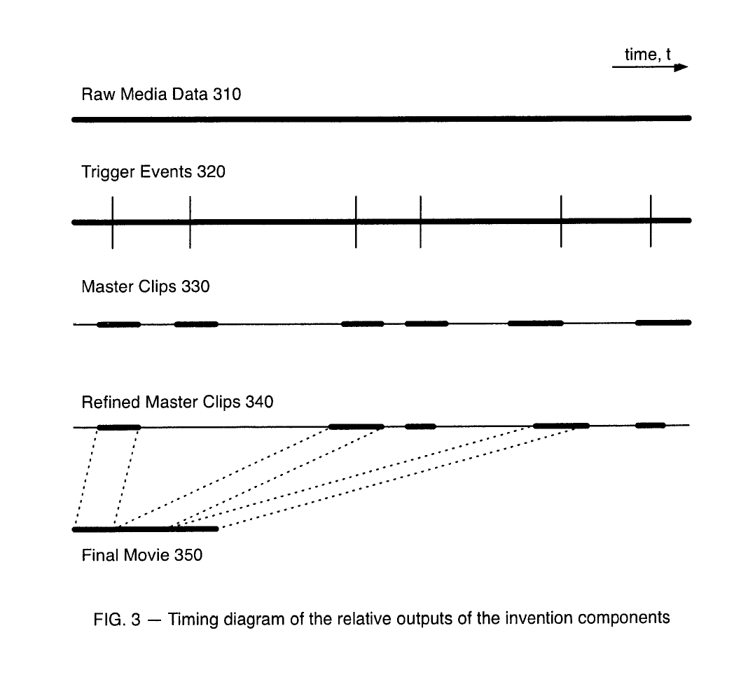

FIG. 3 shows a figurative example of the timing output of some of the various components. Raw media data 310 is the data from activity recording device 205. Trigger events 320 are the output events from triggers 226. Master clips 330 are derived from MHL data in MHL data storage 227 and represents the contents of the MHL media in MHL media storage 230. Refined master clips 340 represents the contents of MHL media 230 after MHL evaluation unit 135 has operated on the rough cut clips. Final movie 350 is an example of one of the possible summary movies created by summary movie creation unit 240.

Certain embodiments include the implementation of the above for automatic identification of potentially interesting events (or highlights) while managing the limited memory and bandwidth of the mobile device. Furthermore, computation for this function is kept low by using sensor data, social data, and other metadata instead of relying solely on the content of the captured video and audio.

The output is an automatically generated summary video. In one embodiment, the system enables the user to make some alterations to the video. In one embodiment, the system enables the user to make adjustments, such as, for example, but not limited to longer, shorter, extra, or fewer highlights.

In one embodiment, to preserve bandwidth, most, if not all, functions are performed on the mobile device. Thus, the raw video data does not need to be uploaded for a summary video to be created.

In one embodiment, these embodiments are computationally efficient because it includes sensor, social, and other metadata for highlight detection. The sensor data, or metadata, is input to the triggers described above.

To preserve memory, the highlights are detected from the video stream and affected nominally in real-time. This affects include trimming to just the temporal clip of interest, or altering the resolution, bit-rate, frame-rate, audio quality, etc. to create a better quality clip.

Referring back to FIG. 2, activity recording device(s) 205 capture the activity in real-time. This captured media data is stored in memory in a media buffer. In one embodiment, the amount of memory is insufficient to store all the media data from an activity, and the memory is organized as a First In, First Out (FIFO) device. The amount of memory determines how long (latency) the rest of the system has to respond to the triggers before the media data is lost. In another embodiment, this memory ranges from only a fraction of a second, or a few video frames, to several minutes.

As before sensors 215 feed data in triggers 226. Triggers 226 respond to the sensor data and/or the media data to determine interesting events. The data related to these events are sent to MHL data 227 which extracts the corresponding media data from MHL media 230. The media data is associated with timestamps (frames of video). In one embodiment, the memory in MHL media 230 allows random access to the captured media data for this operation even though it is being managed as a FIFO. In an embodiment where the memory access is strictly FIFO, then the video extraction synchronizes the timing to extract the media data. The video is accessed in order. When the media data time corresponding to the start time of a highlight is reached, the media is saved. Then, when the media data corresponding to the end time of the highlight is reached, the new media data is discarded until another highlight start time is encountered. MHL data 227 places the media data in MHL media 230 store for further processing and eventual use in creating the summary video. These operations must occur before the media data is lost from MHL media 230. This defines the latency and the real-time nature of this system.

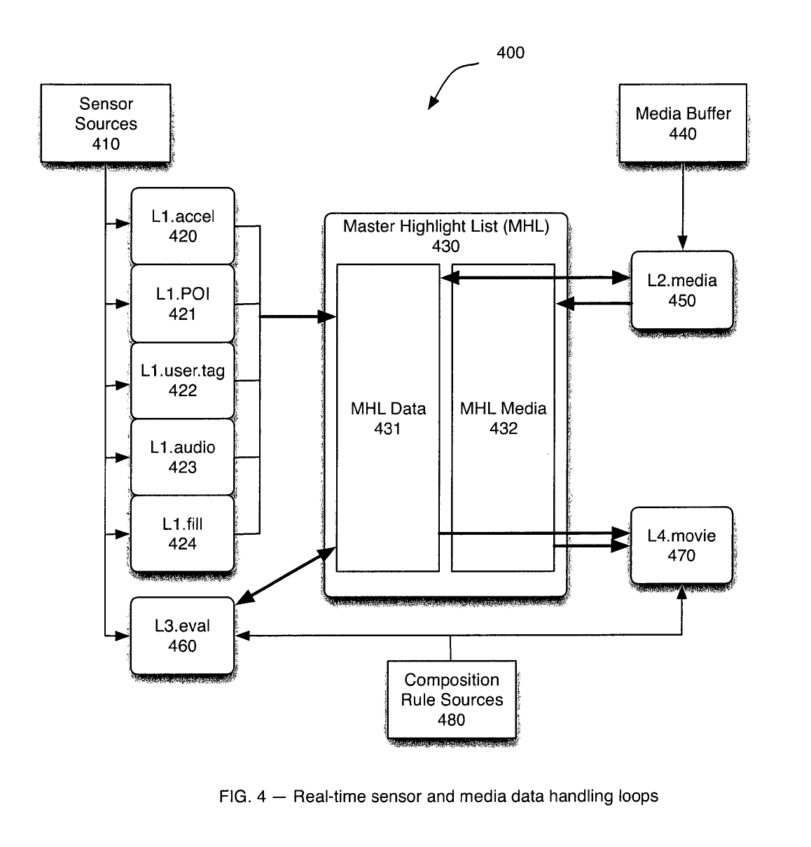

To understand in greater depth the function of one embodiment of the real-time loop, refer to FIG. 4. Sensors sources 410 provide sensor data from a number of different types of sensor. Embodiments can have different sensors. The sensors used in a given embodiment may be based on availability and usefulness for a given activity. For example, in a motion-based sporting activity, such as cycling, GPS, accelerometers, and gyroscope sensors are useful. In a spectator activity, like watching a children's soccer match, these sensors are less useful while audio and user tagging are more useful.

In one embodiment, media buffer 440 in FIG. 4 comes from, or is the same as, activity recording device 205 in FIG. 2, and the data includes real-time captured media such as video, audio, annotation, etc. Note that annotation can be derived from the sensors. For example, in some embodiments it is desirable to indicate the speed as annotation on the summary video.

Additionally, there are a number of system and user preferences that can impact the operation of the system and the composition of the summary movies. For example, factors like movie length, transition types, annotation guides, and other parameters are delivered via composition rule sources 480. Note that in one embodiment, there are more than one set of preferences corresponding to more than one summary movie.

In one embodiment, to perform the process there are at least four loops, or categories of loops. In one embodiment, the loops are code that is executed over and over again. A loop can be triggered by an event, e.g., new data coming in to the buffer, or it can run on a timer. The first loop is the sensor data triggers shown as L1.accel 420, L1.POI 421, L1.user.tag 422, L1.audio 423, L1.fill 424. In one embodiment, these triggers work in parallel and in real-time given the latency offered by media buffer 440. In one embodiment, most of these triggers use only one type of sensor data as input, but in another embodiment, some of the triggers may incorporate multiple types of sensor data. The output of these trigger loops is placed in MHL 430, MHL Data storage 431.

Responding the data in MHL data storage 431 is the second loop, referred to herein as L2.media 450. This loop is responsible for discerning which media data is relevant for a trigger event, extracting the media data from media buffer 440, and placing it in MHL 430, MHL media 432. In one embodiment, this loop also runs in real-time with latency.

The third loop, referred to herein as L3.eval 460, performs many functions. The L3.eval responds to MHL data storage 431 and evaluates the relative importance of different events. L3.eval 460 has access to the sensor data and the trigger events. In one embodiment, with this input, L3.eval 460 creates an event ranking based on more global optimization than any of the individual triggers in the first loop L1. That is, L3.eval 460 has all of the highlight data available from all the trigger events. Furthermore, all of the trigger events are scored based on how strong the trigger event is. Therefore, L3.eval 460 can evaluate highlights from different trigger event sources, determine which highlights should be merged if there is redundancy or overlap, and determine which highlights should be preserved or discarded to save memory.

In one embodiment, a second function of L3.eval 460 is to set, reset, and adapt the thresholds and other criteria (e.g., time range of a highlight, scoring of a highlight, etc.) of triggers in L1 based on the sensor data and trigger results so far. For example, if an activity is resulting in too many events from a trigger, a threshold indicating the level at which an event is triggered can be raised, and vice versa. For example, if the activity is a go cart ride and there are too many trigger events created by measuring signals from the accelerometers and if the threshold is set for a 0.5G lateral acceleration, L3.eval 460 could raise that threshold to 0.8G. That would reduced the number of trigger events detected. Then L3.eval 460 measures again. If the number is still too high, then the threshold is raised again. If it is now too low, the threshold can be lowered. In one embodiment, this is performed on a continuing basis.

The criterion for whether there are too many (or too few) trigger events from a L1 loop can have many variables. For example, the most important variable is the amount of MHL memory available for media storage. If this is running short, L3.eval 460 changes thresholds to reduce the number of events. If this is not being filled, L3.eval 460 changes the thresholds to increase the number of events. Another criterion example is a desire to provide a mix of highlight sources. If there are a huge number of acceleration sourced triggers compared to manual triggers or geolocation triggers in one embodiment, L3.eval 460 sets the thresholds accordingly.

In one embodiment, a third function of L3.eval 460 is to manage the media data in MHL media 432. In one embodiment, MHL media storage 432 is a limited memory buffer. If this buffer approaches capacity before the end of an event, L3.eval 460 makes decisions about the media. These decisions include removing less important highlights or reducing the resolution, bit-rate, frame-rate on some, or all, of the highlights stored in MHL media 432. In one embodiment, in such a case, the less important highlights are identified based on their relative importance score. In one embodiment, decisions to remove less important highlights are made after media and signals that are not associated with highlights have already been removed.

In one embodiment, a fourth function of L3.eval 460 is to inform the L4.movie 470 loop on highlights for movie creation.

In one embodiment, L3.eval 460 responds to real-time events and the latency but, since it affects MHL data storage 431, MHL media 432, and the non-real-time settings for the L1 loop triggers, it does not have to respond in real-time.

The fourth loop, referred to herein as L4.movie, creates one or more summary movies based on the data given from MHL data storage 431, L3.eval 460, and video recorder sources 480. Using this data, L4.movie 470 extracts highlight media data from MHL media storage 432 and creates a summary movie. This function can be performed in real-time with any latency or it can be performed after the conclusion of the activity. Furthermore, in one embodiment, multiple summary movies are created corresponding to different output preferences. In one embodiment, there is an interface that allows user interaction and adjustment to the summary movie creation process of L4.movie 470.

These four loops are described individually in greater detail below starting with the triggers. In these examples, five types of sensor sources are described. However, any given embodiment may use different sensors and/or a different number of sensors. In fact, for some embodiments, the sensor signals used might vary according the activity being captured.

The triggers respond to different types of sensor data. Sensor sources 410 provides sensor data from the sensors in response to triggers (420-424). Also, the sensor data is preserved and, in one embodiment, uploaded for use in machine learning refinement of the trigger parameters based on system-wide, user, and activity context. L3.eval 460 adapts parameters and thresholds used in the individual triggers in real-time (and not necessarily constrained to the latency defined by media buffer 440). In one embodiment, each trigger writes a new record for each detected event in MHL data storage 431. Examples of the information for each event includes the following (written in JSON for clarity):

```
{ “type”: “candidate”,
      “L1.attr”: {
        “startEpoch”: 1396204165532,
        “endEpoch”: 1396204172532,
        “durationSec”: 7.0,
        “L1.score”: 2.0,
        “L1.type”: “start” <finish> <filler> <POI> <user.Tag>
        <accel> <audio>
      }
}
```

Note that the start and end times are given in int(epoch*1000) where epoch is the number of seconds since 00:00:00 1 Jan. 1970 UTC.

L1.accel 420 is a trigger that works on the motion elements captured by the gyro and accelerometers of sensor device such as, for example, an iPhone. In this trigger, each of these signals is combined, filtered and compared to a threshold. The length of the highlight is determined by when the filtered acceleration goes above the threshold to the point where it falls below the threshold. The threshold is preset according to what is known about the user and activity. In one embodiment, it can be adapted by L3.eval 460 during the activity.

In one embodiment, L1.POI 421 uses the latitude and longitude signals from a GPS sensor to determine the distance from a predetermined set of Points of Interest (POI). The set of POIs is updated based on machine learning of these and other sensors offline (not shown in FIG. 4). In one embodiment, the distance for each point is compared to a threshold distance, and this threshold differs according to the user, activity, individual POIs, and a dynamically adaptable weighting determined by L3.eval 460.

L1.user.tag 422 is a user initiated signal in real-time that denotes an event of importance. Different embodiments include one or more interface affordances to create this signal. For example, in one embodiment, a change (or attempted change) in audio volume on a smart phone creates the tag. In this case, most of the mechanisms for changing volume would have the tagging affect (e.g., pressing a volume button, using a bluetooth controller, voice control, etc.). Another example of an affordance is tapping the screen of a smart phone (e.g., an iPhone) at a certain location. Another example is the using the lap button of an activity computer like a Garmin cycle computer. Any device and any action where user intervention can be detected and the resulting timestamp accessed can be used for user tagging.

In one embodiment, L1.user.tags can have different meanings depending on the context (e.g., group, user, activity, recording state, etc.) and the frequency of tags, duration of tags, and other functions. For example, in one embodiment, several tags within a short period of time (e.g., 2 seconds) is used to convey that the event occurred before the tag. In one embodiment, two in a row means 15 seconds before, three in a row means 30 seconds before, and so on. Many different tagging interfaces can be created this way. The meanings of tagging is, in one embodiment, influenced by L3.eval 460.

In one embodiment, L1.audio 423 uses some, or all, of the audio signals created by activity recording device 210 of FIG. 2. This is an example of sensor data being used for both triggers and media data. In one embodiment, L1.audio 423 filters the audio signal and compares it to thresholds to determine the position and duration of highlights. In one embodiment, the thresholds and filter types can be influence by prior learning of the user and activity type and adapted by L3.eval 460.

In one embodiment, L1.fill 424 creates start, finish, filler highlights. A little bit different than other signals, this one detects the “start” of and event, the “finish” of an event, and so called “filler” highlights. Filler highlights are a detection of a lack of events by other triggers and is prompted by L3.eval 460. These are often used to create a summary movie that tells a complete story.

The second loop, L2.media 450, responds to the highlight data deposited in MHL data storage 431. In one embodiment, this is a real-time loop function that is started by an interrupt from MHL data storage 431. In another embodiment, this is a real-time loop function that is started by polling of MHL data storage 431.

L2.media 450 reviews the MHL data and extracts media data (movie clip) from media buffer 440, if available. If the media is not yet available, the L2.media retries the access either on a periodic basis or when the data is known to be available. There are cases where the media data is not available because the L1 events include time that is in the future and not yet recorded, for example a user tag with a convention to “capture the next 30 seconds.” Also, there may be implementation-based access limitations into media buffer 440.

When L2.media 450 extracts the media data from media buffer 440 it includes padding on both sides of the highlight clip. This padding can be adaptive and/or dependent on the type of highlight. The padding can also be adapted during the activity with input from L3.eval.

L2.media 450 writes the media data to MHL media 432. The repository is sometimes referred to as the Master Clips or the Rough Clips.

L2.media 450 writes new data (in this case the “vps” element) into an existing MHL data storage 431 element. Note that the mediaID is some sort of pointer to the media. The following example uses an MD5 hash for example.

```
{ “type”: “candidate”,
      “L1.attr”: {
        “startEpoch”: 1396204165532,
        “endEpoch”: 1396204172532,
        “durationSec”: 7,
        “L1.score”: 2.0,
        “L1.type”: “start” <finish> <filler> <POI> <user.Tag>
        <accel> <audio>
      }
      “vps ”: [
        {
              “L2.type”: “primaryVideo”,
              “L2.startEpoch”: 1396204160532,
              “L2.endEpoch”: 1396204177532,
              “mediaID”: “c1516d0b9ba114d5e6c5f3637e2b0442”
        }
      ]
}
```

In one embodiment, the third loop function, L3.eval 460, has many roles. It calculates the relative importance of highlight events represented in MHL data storage 431. It signals the adaptation of trigger conditions in the L1.x (420-424). L3.eval 460 signals adaption and control of the L4.movie 470 movie creation module. In one embodiment, it manages the rough cut clips in MHL media 432. Finally, L3.eval writes to MHL data storage 431 adding new or updating scoring, positioning, and annotation. Below is an example updated record.

```
{ “type”: “candidate” “master”,
      “L1.attr”: {
        “startEpoch”: 1396204165532,
        “endEpoch”: 1396204172532,
        “durationSec”: 7,
        “L1.score”: 2.0,
        “L1.type”: “start” <finish> <filler> <POI> <user.Tag>
        <accel> <audio>
      }
      “L3.attr”: {
        “position”: 3,
        “norm.score”: 1.23
      }
      “vps ”: [
        {
              “L2.type”: “primaryVideo”,
              “L2.startEpoch”: 1396204160532,
              “L2.endEpoch”: 1396204177532,
              “mediaID”: “c1516d0b9ba114d5e6c5f3637e2b0442”
        },
        {
              “L3.type”: “annotation”,
              “L3.title”: “This is the title for this Highlight”,
              “L3.speed”: 6.0,
              “L3.speed.unit”: “mph”,
              “L3.grade”: 9.2
        }
      ]
}
```

The last loop in certain embodiments is L4.movie 470. In one embodiment, the function of L4.movie 470 creates one or more summary movies based on input from L3.eval 460, the sources 480, and MHL data storage 431. It uses the movie clips from MHL media storage 432 to create these movies.

By the methods and apparatus described above, embodiments enable the building of systems that (a) capture activities from one or more viewpoints, (b) detect interesting events with a variety of automated means, (c) continually adapts those detection mechanisms, (d) manages a master clip repository, (e) and automatically creates summary movies. The elements of certain embodiments allow implementation in constrained system environments where bandwidth, computation, and memory are limited.

Events are detected in real-time with limited latency. The master highlights are managed in real-time with limited latency. Adaption of the event triggers is achieved in real-time with limited latency. Thus, this functionality can be achieved with the memory on the smart device limited by the device itself. Because this is performed on the device, no (or minimal) bandwidth is required for the real-time operation. In one embodiment, all of this function is performed on the smart device, utilizing only local computational power (no server computation need be invoked).

To better illustrate the embodiments possible with this technology, a number of examples are offered below.

### Examples of Memory Adaption

There are a variety of types of memory available in smart devices. For a given device, with given types of memory available (e.g., volatile RAM, flash memory, magnetic disk) and the arrangement of the memory (e.g., CPU memory, cache, storage), there are different embodiments of this technology that would be optimal. However, for simplicity, these examples will all presume that there is only one type and configuration of memory and preserving memory in one operation would necessarily free memory for another operation. (This is a reasonable approximation for the memory in the popular Apple iPhone 5s smart devices.)

For instance, using Apple's iPhone 5s smart device with Apple's camera application to capture video, with resolution at 1080p (1920 pixels wide by 1080 lines high), 30 frames per second, H.264 video compression, two channel audio rate of 44,100 kHz, AAC audio compression, the bitrate of the resulting movie file is about 2 MB/second or 7.2 GB/hour. For the Apple iPhone line, memory varies from 16 GB, 32 GB, and with more modern versions 128 GB. (Memory is the main cost differentiator for the current Apple iPhone product line.) It is clear that long videos approaching an hour, or more, would challenge most iPhones given that this memory must also contain all of the users other applications, data, and the operating system.

Given that most video is best enjoyed as an edited compilation of the “highlights” of an event rather than an unedited raw video capture, embodiments herein are used to reduce the memory burden using real-time automated highlight detection and media extraction.

For an embodiment of this example, consider a memory capture buffer of, say, 60 MB. This is a modest size for the active memory for an application in Apple's iOS. Approximately 30 seconds of video and audio is captured and stored in this buffer. The buffer is arranged in a FIFO (first in, first out) configuration, at least for writing the media data. There are several possible embodiments of this FIFO. There could be a rolling memory pointer that keeps track of the next address to write data. There could be two, or more, banks of memory (e.g., 30 MB each) and when one bank is filled, the system switches the writing to the next bank. Whichever FIFO system is implemented, the capture buffer will never be greater than 60 MB, and there will always be around 30 seconds of video and audio data available for the rest of the system to work with.

In parallel to the video and audio capture, a number of other signals are captured (e.g., GPS, acceleration, and manual tags). These signal streams are processed in the L1 loops in parallel to create a Master Highlight List (MHL). (The memory required for the signal data vary, however in this example they are processed immediately and discarded. In other embodiments, the signal data is preserved for later processing to refine highlights. In any case, the memory required for these signals is a small fraction of that required for the video data.)

The L2.media loop takes the MHL data and maps it onto the media data in the FIFO described above. Then the L2.media loop extracts the media clips corresponding to the highlights and stores this media in the MHL media storage. In one embodiment, the method the L2.media loop uses to extract the data is a function of how the FIFO was implemented. If the “FIFO” is actually a rolling buffer or multiple banks of memory, the reading of the data could be random rather than ordered (First In, Random Out).

The clips that are extracted are the rough cut that include the highlights. That is, based on certain rules (e.g., heuristic and machine-learned), the highlights are padded on both sides to allow future variation and ability to edit.

In this example, the memory used to capture the movie and the associated signals is (more or less) fixed. The data is that is growing is the MHL data (relatively trivial control data) and the MHL media (the rough cut of the media related the highlights). In many embodiments, it is acceptable for this data to grow without limit. In most cases, this will be far below the data rate of the original movie. However, in the embodiment of this example, the MHL media data storage is also managed.

If a summary, or compilation, movie of no more than two minutes is considered desirable, then given that the rough cuts padded to allow some flexibility and the system will need to be capable of storing more highlights than are used in the final cut movie, assume that eight minutes of movie data is stored, or around a 1 GB of data. (Note that this store is independent of the length of the original, or raw, movie data.)

In one embodiment, L3.eval 460 (among other functions) continually monitors how close to the MHL data and media store limit the current set of data is. When the data approaches the limit, the L3.eval loop compares each of the current highlights with respect to each other. Using sources that were assigned by the L1 loops and other information (e.g. relative size; density of the same type (same L1); density around a certain time; need for start, finish, and filler highlights to tell the story) the L3.eval loop determines which of the highlights and media data to remove.

In one embodiment, the L3.eval loop could cause the media to be reduced in size rather than removed entirely. For example, the rough cut could be trimmed in time, the frames per second could be reduced, the resolution could be reduced, and/or the compression bitrate could be reduced. Likewise, the sample rate and compression factors for the audio could reduce the size, although not as significantly as any of the video compression measures.

In another embodiment, the L2.media loop functions as a quality filter. Instead of extracting only the rough cuts around the highlights, as in the above example, the incoming movie data is reduced in size everywhere except the rough cuts which are preserved at the highest quality. Reductions in size can be achieved by reducing the resolution, frames per second, bitrate, and/or audio sample rate.

### Using the Cloud as a Repository

In another example, memory is reduced by using a cloud memory resource as a repository. If the bandwidth is sufficient, the entire raw movie data stream could be sent to the cloud. However, it is rarely the case that that much bandwidth is available and/or affordable.

In this example, the cloud is used to store the highlight rough cuts. After the L2.media loop extracts the roughs cut data, it is transmitted (or queued for transmission) to the cloud repository. Using unique keys to identify the rough cut, in one embodiment, it can be downloaded, or in another embodiment, streamed as needed by the L4.movie production loop.

In another embodiment, the rough cut at full size is uploaded to the cloud repository and a reduced sized version is saved in the MHL media data storage. In one embodiment, the size is reduced by reducing resolution, frames per second, bitrate, and/or audio sample rate.

In another embodiment, the same approach is used to manage the overall store of rough cuts. That is, after several movies are captured, the stored rough cuts for making final cut movies (if they are created adaptively on the fly) or the final cut movies themselves can become quite large. One approach for this is to use the cloud repository. The rough cuts are uploaded to the cloud and either removed or reduced in size on the device. Then, when needed, in one embodiment, the rough cuts are downloaded, or, in another embodiment, streamed to the device. This also enables easy sharing of the movie content between devices.

In one embodiment, the rough cuts are all uploaded to the cloud as soon as a satisfactory (e.g., high bandwidth, low cost) network connection is available. On the device, representative “thumbnail” images of the final cut movies and/or the highlight are stored. The user interface presents these thumbnail images to the user. When the user selects a thumbnail for viewing (or sharing, or editing), the appropriate rough cuts are downloaded to the client. In another embodiment, the rough cuts are streamed instead of downloaded.

### Examples of Computational Adaption

Different devices have different computation capabilities. Some devices include graphic processing units and/or digital signal processing units. Other devices offer more limited central processing units. Furthermore, even if a device has significant computational capabilities, these resources might need to be shared at key times.

The most significant processing burden in one embodiment of a system described herein is video processing. It is assumed that the device has sufficient resources available for reasonable video processing. This is certainly true of the Apple iPhone 5s in the previous example.

The next most significant processing burdens are in the various L1 loops. In one embodiment, if processing capability is limited, the signal data is stored and processing in certain of these loops are suspended. If the memory storage is not a problem, i.e. the limits in the previous example do not apply, then all the processing can be performed after the movie capture.

In one embodiment, limited computation in the L1 loops is performed with lower thresholds. This results in more highlights and more rough cut clips. In one embodiment, the padding of the rough cuts is greater. In both of these types of embodiments, the signals are further processed after the movie capture and the highlights and rough cuts modified accordingly.

### Using the Cloud for Computation

In one embodiment, the computation required by the some or all of the L1 loops is performed by cloud-based computational resource (e.g., dedicated web service). The signal data associated with the L1 loops to be performed in the cloud are uploaded or streamed to the cloud. Once a highlight is identified by the L1 loop in the cloud, the device is notified, using a notification service and communication functionality such as the Apple Push Notification Service, or the device polls a site, such as a REST call to the dedicated web service or a query of an Amazon Web Service Simple Queue Service. Once the device is notified of a highlight, the MHL data is updated and the L2.media loop can execute the media extraction for that highlight This example requires time for the signals to be uploaded, the web service to detect the highlights, and the device to be notified of a highlight before the media in the capture buffers is overwritten. In one embodiment, the capture memory buffer size is increased to enable function.

### Examples of Communication Bandwidth Adaption

Different devices have different types of communication capabilities available, and the same device may have connection to different types of communication capabilities available depending on their location. For example, WiFi Internet access may be only intermittently available. Likewise, cellular data may be intermittently available. Both WiFi and cellular connections can vary in speed and cost depending on the device, location, or cellular provider.

When communication is not available, slow, and/or expensive, in one embodiment, the system adapts and reduces the reliance on one or more forms of communication. In one embodiment, all (or some portion) of the computation is performed on the device when communication slows, is expensive, or is unavailable. In one embodiment, the upload of raw, rough, or final cuts is delayed until sufficient and/or inexpensive communication is available.

### Examples of Energy Adaption

Different devices have different energy consumption patterns, different batteries, and may or may not be connected to a continuous power source.

This system's greatest use of power is, potentially, for communication. The system's second greatest use of power is probably the movie capture system, and then the signal capture and computation. In one embodiment, the energy available is detected as the energy is consumed by the various functions used by this system. In the case that energy is an issue (e.g., reaches a threshold amount (e.g., a limit) of remaining power), methods for reducing communication bandwidth and/or computation can be used even if there is otherwise sufficient bandwidth and computation resources respectively. The energy savings of each type of function (reduced bandwidth, reduced computation) is characterized for each device. For a given device, the energy savings is derived from reducing the most energy consuming function by the methods described above.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A video editing process performed by a capture device, the process comprising:
editing, on a capture device, raw captured media data by extracting media data for a set of highlights in real-time using tags that identify each highlight in the set of highlights from signals generated from triggers;
creating, on the capture device, a video clip by combining the set of highlights; and
processing, during one or both of editing the raw input data and creating the video clip, a portion of the raw captured media data that is being stored in a memory on the capture device but not included in the video clip during one or both of editing the raw input media data and creating the video.

2. The video editing process defined in claim 1 wherein the capture device uses a target limit with respect to limiting constraint of the capture device and processing the portion of the raw captured media data that is stored in a memory of the capture device but not included in the video clip to cause the capture device to operate the video editing process within the target limit.

3. The video editing process defined in claim 1 wherein creating the video clip is performed while editing the raw input media data.

4. The video editing process defined in claim 1 wherein the video clip is a rough cut clip.

5. The process defined in claim 1 wherein the constraint is memory of the capture device and further wherein processing a portion of the raw captured media data comprises discarding, by the capture device, material from the raw input media data that is not part of the video clip.

6. The process defined in claim 5 wherein discarding, by the capture device, material from the raw input media data that is not part of the video comprises discarding all the raw input media data that is not part of the video.

7. The process defined in claim 1 wherein the constraint is memory of the capture device and further comprising processing another portion of the raw captured data by storing at least a portion of the raw input data containing media related to highlights at a lower bitrate, resolution, frame rate, quality and/or resolution than when captured.

8. The process defined in claim 1 wherein the highlights are generated based on a master highlight list generated based on processing of tags from the tagging.

9. The process defined in claim 1 further comprising changing the set of highlights on the fly, thereby causing a changing of the video clip, by evaluating one or more additional signals and additional media during the editing of the captured raw input media data.

10. The process defined in claim 9 wherein the highlights are generated based on a highlight list generated based on processing of tags from the tagging, and changing the set of highlights comprises refining the highlight list as the one or more additional signals and additional media are evaluated

11. The process defined in claim 10 further comprising evaluating the highlight list to determine one or more of a relative scoring, context, position, and importance of the highlights and their associated clips based on one or more of media data, sensor data, user preferences and learning data.

12. The process defined in claim 1 wherein editing the raw captured media data and creating the video clip are performed as part of a real-time loop that inputs the signals and the raw captured data and outputs a highlight list and the video clip.

13. The process defined in claim 12 wherein latency of execution of the real-time loop allows for extraction of media within the memory constraint of the capture device.

14. The process defined in claim 1 wherein the raw captured media data comprises one or more of annotation, audio and video.

15. The process defined in claim 1 wherein editing the raw captured media data is based on parameters that include a time range of a highlight.

16. The process defined in claim 1 further comprising performing a plurality of loops to edit the raw captured media data and create the video clip.

17. The process defined in claim 16 wherein performing a plurality of loops comprises performing a first loop that collects signal data and creates one or more real-time triggers and highlights based on collected signal data.

18. The process defined in claim 17 wherein performing a plurality of loops comprises performing a second loop that extracts media relevant to the triggers and highlights.

19. The process defined in claim 18 wherein performing a plurality of loops comprises performing a third loop that evaluates the highlights to determine a relative weighting among the highlights.

20. The process defined in claim 17 wherein performing a plurality of loops comprises performing a second loop that sets one or more parameters for other loops of the plurality of loops.

21. The process defined in claim 20 wherein performing the second loop sets a threshold for one trigger for the first loop.

22. The process defined in claim 17 wherein performing a plurality of loops comprises performing a second loop that performs memory management by altering media data that is being stored in the memory on the capture device.

23. The process defined in claim 22 wherein the processing of the portion of the raw captured media data that is not part of the video clip comprises one or more of removing less important highlight data, and reducing one or more of resolution, bit-rate, frame-rate of highlights stored the memory.

24. The process defined in claim 17 wherein performing a plurality of loops comprises performing a second loop that creates a set of highlights and a third loop that creates a movie form the set of highlights.

25. The process defined in claim 16 wherein one loop of the plurality of loops is operable to generate highlights and is performed in a cloud-based resource, and further comprising:
receiving a notification from the cloud-based resource that a highlight has been identified; and
performing another loop of the plurality of loops to perform media extraction for the media with respect to the highlight.

26. The process defined in claim 1 wherein editing the raw input media data is suspended temporarily in response to determining that energy for the capture device has reached a predetermined limit.

27. The process defined in claim 1 further comprising communicating one or more of media data or metadata associated with highlights in a highlight list to a remote location based on whether one or more forms of communication are available to the capture device.

28. A device comprising:
a camera to capture video data;
a first memory to store captured video data;
a display screen coupled to the one or more processors to display portions of the captured video data;
one or more sensors to capture signal information; and
one or more processors coupled to the memory and operable to process the captured video data by
editing, on a capture device, raw captured media data by extracting media data for a set of highlights in real-time using tags that identify each highlight in the set of highlights from signals generated from triggers,
creating, on the capture device, a video clip by combining the set of highlights, and
processing, during one or both of editing the raw input data and creating the video clip, a portion of the raw captured media data that is being stored in a memory on the capture device but not included in the video clip during one or both of editing the raw input media data and creating the video.

29. The device defined in claim 28, wherein the capture device uses a target limit with respect to limiting constraint of the capture device and is operable to process the portion of the raw captured media data that is stored in a memory but not included in the video clip to cause the capture device to operate the video editing process within the target limit.

30. The device defined in claim 28 wherein the one or more processors are operable to create the video clip while editing the raw input media data.

31. The device defined in claim 28, wherein the constraint is the memory and wherein the processing of the portion of the raw captured media data is performed by discarding material from the raw input media data that is not part of the video clip.

32. The device defined in claim 28, wherein the one or more processors are operable to discard material from the raw input media data that is not part of the video comprises discarding all the raw input media data that is not part of the video.

33. The device defined in claim 28, wherein the constraint is the memory and wherein the one or more processors are operable to process another portion of the raw captured data by storing at least a portion of the raw input data containing media related to highlights at a lower bitrate, resolution, frame rate, quality and/or resolution than when captured.

34. The device defined in claim 28, wherein the one or more processors are operable to change the set of highlights on the fly, thereby causing a changing of the video clip, by evaluating one or more additional signals and additional media during the editing of the captured raw input media data.

35. The device defined in claim 34, wherein the highlights are generated based on a highlight list generated based on processing of tags from the tagging, and wherein the one or more processors are operable to change the set of highlights comprises refining the highlight list as the one or more additional signals and additional media are evaluated

36. An article manufacturer having one or more non-transitory computer readable storage media storing instructions which, when executed by a device, cause the device to perform a method comprising:
editing, on a capture device, raw captured media data by extracting media data for a set of highlights in real-time using tags that identify each highlight in the set of highlights from signals generated from triggers;
creating, on the capture device, a video clip by combining the set of highlights; and
processing, during one or both of editing the raw input data and creating the video clip, a portion of the raw captured media data that is being stored in a memory on the capture device but not included in the video clip during one or both of editing the raw input media data and creating the video.
